(19) United States
(12) Patent Application Publication
(10) Pub. No.: US 2013/0337683 A1
(43) Pub. Date: Dec. 19, 2013

(54) Coaxial Connectors withPressure-Enhanced Continuity

(71) Applicants: Robert J. Chastain, Maumelle, AR (US); Glen David Shaw, Conway, AR (US); David A. Kelly, Cabot, AR (US); Linan Gao, Guangdong (CN)

(72) Inventors: Robert J. Chastain, Maumelle, AR (US); Glen David Shaw, Conway, AR (US); David A. Kelly, Cabot, AR (US); Linan Gao, Guangdong (CN)

(21) Appl. No.: 13/527,521

(22) Filed: Jun. 19, 2012

(51) Int. Cl. H01R 9/05

(52) U.S. Cl. 439/578

(57) ABSTRACT

Axially compressible, F-connectors for conventional installation tools for interconnection with coaxial cable include biasing fingers for promoting electrical continuity despite inadequate nut tightening. Each connector has a rigid nut, a post penetrating the nut, a tubular body, and an end cap. The conductive post coaxially extends through the connector, linking the nut and body. A post end penetrates the coaxial cable. Each connector body comprises a plurality of radially, spaced apart biasing fingers for pressuring the nut to insure mechanical and electrical contact with the post. In one form of the invention the fingers border spaced apart notches in the body, and extend parallel with the axis of the connector. In an alternative embodiment, fingers are defined between radially spaced-apart slots on a flange associated with the body.

### BACKGROUND OF THE INVENTION

1. Field of the Invention

The present invention relates generally to coaxial cable connectors. More particularly, the present invention relates to coaxial F-connectors adapted to insure the establishment of a proper ground during installation. Known prior art is classified in United States Patent Class 439, Subclasses 241, 247, 322, 548, 553, 554, 585, and 587.

2. Description of the Related Art

Popular cable television systems and satellite television receiving systems depend upon coaxial cable for distributing signals. As is known in the satellite TV arts, coaxial cable in such installations is terminated by F-connectors that threadably establish the necessary signal wiring connections. The F-connector forms a “male” connection portion that fits to a variety of receptacles, forming the “female” portion of the connection.

F-connectors include a tubular post designed to slide over coaxial cable dielectric material and under the outer conductor at the prepared end of the coaxial cable. The exposed, conductive sheath is usually folded back over the cable jacket. The cable jacket and folded-back outer conductor extend generally around the outside of the tubular post and are typically coaxially received within the tubular connector. A continuity contact between the sheath and the body of the connector is needed. Moreover, contact must be made with the threaded head or nut of the connector that should contact the female socket to which the connection is made.

F-connectors have numerous advantages over other known fittings, such as RCA, BNC, and PL-259 connectors, in that no soldering is needed for installation, and costs are reduced as parts are minimized. For example, with an F-connector, the center conductor of a properly prepared coaxial cable fitted to it forms the “male” portion of the receptacle connection, and no separate part is needed. A wide variety of F-connectors are known in the art, including the popular compression type connector that aids in rapid assembly and installation. Hundreds of such connectors are seen in U.S. Patent Class 439, particularly Subclass 548.

However, the extremely high bandwidths and frequencies distributed in conjunction with modern satellite installations necessitates a variety of strict quality control factors. For example, the electrical connection established by the F-connector must not add electrical resistance to the circuit. It must exhibit a proper surge impedance to maintain a wide bandwidth, in the order of several Gigahertz. Numerous physical design requirements exist as well. For example, connectors must maintain a proper seal against the environment, and they must function over long time periods through extreme weather and temperature conditions. Requirements exist governing frictional insertion and disconnection or withdrawal forces as well.

Importantly, since a variety of coaxial cable diameters exist, it is imperative that satisfactory F-connectors function with differently sized cables, such as RG-6 and RG-59 coaxial cables that are most popular in the satellite television art.

It is important to establish an effective electrical connection between the F-connector, the internal coaxial cable, and the terminal socket. One facet of the problem involves electrical continuity that must be established between the connector nut and the usually-barbed post within the connector. More particularly, it is important to establish a dependable electrical connection between the front nut, the internal post, the post shank, and the coaxial cable sheath.

Proper installation techniques require adequate torquing of the connector head. In other words, it is desired that the installer appropriately tighten the connector during installation. A dependable electrical grounding path must be established through the connector body to the grounded shield or jacket of the coaxial cable. Threaded F-connector nuts should be installed with a wrench to establish reasonable torque settings. Critical tightening of the F nut to the threaded female socket or fixture applies enough pressure to the inner conductor of the coaxial cable to establish proper electrical connections. When fully tightened, the head of the tubular post of the connector directly engages the edge of the outer conductor of the appliance port, thereby making a direct electrical ground connection between the outer conductor of the appliance port and the tubular post; in turn, the tubular post is engaged with the outer conductor of the coaxial cable.

Many connector installations, however, are not properly completed. It is a simple fact in the satellite and cable television industries that many F-connectors are not appropriately tightened by the installer. The common instillation technique is to torque the F-connector with a small wrench during installation. In some cases installers only partially tighten the F-connector. Some installations are only hand-tightened. As a consequence, proper electrical continuity may not be achieved. Such F-connectors will not be properly “grounded,” and the electrical grounding path can be compromised and intermittent. An appropriate low resistance, low loss connection to the female target socket, and the equipment connected to it, will not be established. Unless a proper ground path is established, poor signal quality, and RFI leakage, will result. This translates to signal loss or degradation to the customer.

U.S. Pat. No. 3,648,445 issued Jul. 18, 1942 discloses a shield for eliminating electromagnetic interference in an electrical connector. A conductive shielding member having a spring portion snaps into a groove for removably securing the shield. A second spring portion is yieldable to provide electrical contact between the first shell member and a second movable shell member.

U.S. Pat. No. 3,535,443 issued Sep. 10, 1944 discloses an electromagnetic interference shield for an electrical connector comprising a helically coiled conductive spring interposed between mating halves of the connector. The coiled spring has convolutions slanted at an oblique angle to the center axis of the connector. Mating of the connector members axially flattens the spring to form an almost continuous metal shield between the connector members.

U.S. Pat. No. 3,439,046 issued Jun. 12, 1943 discloses a coaxial connector with an internal, electrically conductive coil spring mounted between adjacent portions of connector. As an end member is rotatably threaded toward the housing, an inwardly directed annular bevel engages the spring and moves it inwardly toward an electrically shielded portion of the cable. The spring is compressed circumferentially so that its inner periphery makes electrical grounding contact with the shielded portion of the cable. It is accordingly among the objects of the invention to provide a cable terminating and grounding connector which is simple in construction and which is far simpler in use and installation than similar devices of the type now in use. This simplicity and greater speed of installation of the connector necessarily result in substantial savings in time and labor cost.

U.S. Pat. No. 5,066,248 issued Nov. 19, 1991 discloses coaxial cable connector comprising a housing sleeve, a connector body, a locking ring, and a center post. A stepped annular collar on the connector body ensures metal-to-metal contact and grounding.

U.S. Pat. No. 4,106,539 issued Aug. 15, 1948 shows a coaxial connector with a resilient, annular insert between abutting connector pieces for grounding adjacent parts. A band having a cylindrical surface is seated against an internal surface. Folded, resilient projections connected with the band are biased into contact. The shield has tabs for mounting, and a plurality of folded integral, resilient projections for establishing a ground.

U.S. Pat. No. 4,423,919 issued Jan. 3, 1954 discloses a connector with having a cylindrical shell with radial flange, a longitudinal key, and a shielding ring fitted over the shell and adjacent to the flange. The shielding ring comprises a detent having end faces configured to abut connector portions when the detent fits within the keyway, whereby the shell is prevented from rotating.

U.S. Pat. No. 4,330,166 issued May 18, 1952 discloses an electrical connector substantially shielded against EMP and EMI energy with an internal, conductive spring washer seated in the plug portion of the connector. A wave washer made from beryllium copper alloy is preferred.

U.S. Pat. No. 6,406,330 issued Jun. 18, 2002 employs an internal, beryllium copper clip ring for grounding. The clip ring forms a ground circuit between a male member and a female member of the electrical connector. The clip ring includes an annular body having an inner wall and an outer wall comprising a plurality of circumferentially spaced slots.

U.S. Pat. No. 7,114,990 issued Oct. 3, 2006 discloses a coaxial cable connector with an internal grounding clip establishing a grounding path between an internal tubular post and the connector. The grounding clip comprises a C-shaped metal clip with an arcuate curvature that is non-circular. U.S. Pat. No. 7,479,035 issued Jan. 20, 2009 shows a similar F-connector grounding arrangement.

U.S. Pat. No. 7,753,405 issued Jul. 13, 2010 discloses an RF seal for coaxial connectors that makes a uniform RF seal on a port even with a range of tightening torques. The seal comprises a flexible brim, a transition band, and a tubular insert with an insert chamber defined within the seal. In a first embodiment the flexible brim is angled away from the insert chamber, and in a second embodiment the flexible brim is angled inward toward the insert chamber. A flange end of the seal makes a compliant contact between the port and connector faces when the nut of a connector is partially tightened, and becomes sandwiched firmly between the ground surfaces when the nut is properly tightened. U.S. Pat. No. 7,892,024 issued Feb. 22, 2011 shows a similar grounding insert for F-connectors.

U.S. Pat. No. 7,524,216 issued Nov. 2, 2010 discloses a coaxial connector comprising a body, a post including a flange having a tapered surface, a nut having an internal lip with a tapered surface, wherein the tapered surface of the nut oppositely corresponds to the tapered surface of the post when is assembled, and a conductive O-ring between the post and the nut for grounding or continuity. Similar U.S. Pat. Nos. 7,545,946 issued Dec. 7, 2010 and 7,892,005 issued Feb. 22, 2011 use conductive, internal O-rings for both grounding and sealing.

U.S. Pat. Nos. 6,332,815 issued Dec. 25, 2001 and 6,406,330 issued Jun. 18, 2002 utilize clip rings made of conductive resilient material such as beryllium copper for grounding. The clip ring forms a ground between a male member and a female member of the connector.

U.S. Pat. No. 6,416,062 issued Apr. 6, 2004 discloses a coaxial cable F connector with an internal coiled spring that establishes continuity. The spring biases the nut toward a rest position wherein not more than three revolutions of the nut into engagement with the shaft are necessary to bring the post of the connector into contact.

U.S. Pat. No. 7,841,896 issued Nov. 30, 2010, and entitled “Sealed compression type coaxial cable F-connectors”, which is owned by the instant assignee, discloses axially compressible, high bandwidth F-connectors for interconnection with coaxial cable. An internal, dual segment sealing grommet activated by compression provides a seal. Each connector nut interacts with a tubular body and a rigid, conductive post coaxially extending through the connector. A post barbed end penetrates the cable within the connector. A metallic end cap is slidably fitted to the body. A tactile system comprising external convex projections on the body complemented by a resilient, external O-ring on the end cap aids installers who can properly position connectors with the sense of touch.

For an adequate design, structural improvements to compressible F-connectors for improving continuity or grounding must function reliably without degrading other important connector requirements. Compressible connectors must adequately compress during installation without excessive force. An environmental seal must be established to keep out water. The coaxial cable inserted into the connector must not be mechanically broken or short circuited during installation. Field installers and technicians must be satisfied with the ease of installation. Finally, the bottom line is that a reliable installation must result for customer satisfaction.

As implied from the above-discussed art, many prior art attempts at enhanced grounding exist. Several solutions involve the addition of a conductive grounding member within the fitting, that physically and electrically bears against critical parts to enhance continuity. However, it is becoming increasingly clear to us that an alternative solution for the above-discussed continuity problem is to modify internal connector parts to specifically pressure critical parts together to force electrical contact. In other words, we have provided an internal pressure-generating connector that enhances continuity without the addition of separate conductive, mechanical grounding apparatus such as inserts, rings, bridges or other apparatus.

### BRIEF SUMMARY OF THE INVENTION

Our coaxial cable connectors are of the compressible type. The connectors comprise a rigid nut with a faceted drive head adapted to be torqued during installation of a fitting. The head has an internally threaded, tubular stem, for threadably mating with a typical socket or receptacle. An elongated, internal post coupled to the nut includes a shank, which can be barbed, that engages the prepared end of a coaxial cable. A hollow tubular body is coupled to the post. When the device is compressed, an end cap is press fitted to the body, coaxially engaging a body shank portion and closing the fitting. Internal O-rings, band seals, or the like may be combined for sealing the connector

In known F-connector designs the internal post establishes electrical contact between the coaxial cable sheath and metallic parts of the coaxial fitting, such as the nut. Also, the elongated, tubular shank extends from the post to engage the coaxial cable, making contact with the metallic, insulative sheath.

However, since improper or insufficient tightening of the nut during F-connector installation is so common, and since continuity and/or electrical grounding suffer as a result, our designs utilize adaptations to the tubular body to mechanically pressure the nut, once the connector is compressed. Body-applied pressures establish a dependable grounding path between the nut and the internal post. All embodiments described herein utilize specially configured connector bodies for encouraging electrical contact between the nut, the post and thus the sheath of the coaxial cable to which the fitting is fastened.

In all embodiments of the invention, the annular end of the body facing the nut is provided with a plurality of integral, offset fingers. The resilient fingers are radially spaced apart at the body front end to urge against and physically contact the nut, once the connector is axially compressed during assembly.

In a preferred form of the invention, the fingers are positioned adjacent radially-spaced apart voids defined in the body, and project towards the nut. Flexibility of the fingers is insured by the notch-like, peripheral voids defined in the body. The voids facilitate flexibility and clearance as the fingers are deflected in assembly. An O-ring may optionally be provided between the post and the nut.

An alternative embodiment utilizes a different finger-mounting arrangement. In the latter design, the body end is provided with a resilient, integral flange that borders a ring groove. The groove, the flange and the body are coaxial. A plurality of flexible, radially spaced-apart fingers are defined around the body flange. In the latter design, the fingers comprise convex projections that are offset from the flange. As before, an O-ring may optionally be provided between the post and the nut.

In each instance, resultant pressure from the fingers promotes continuity between the post and nut. Electrical contact between the post, the nut, and the coaxial cable is thus insured, despite insufficient tightening of the nut.

Thus the primary object of our invention is to promote electrical continuity within an F-connector to overcome electrical connection problems associated with improper installation.

More particularly, an object of our invention is to provide dependable electrical connections between coaxial connectors, especially F-connectors, and female connectors or sockets.

Another object of the present invention is to provide internal structure for promoting grounding contact between the post and nut within improperly-tightened coaxial cable connectors.

A similar object is to provide a proper continuity in a coaxial connector, even though required torque settings have been ignored.

Another object of the present invention to provide reliable continuity between a connector and a target socket or port, even if the connector is not fully tightened.

It is another object of the present invention to provide a compressible coaxial cable connector which establishes and maintains reliable electrical continuity.

It is still another object of the present invention to provide such a coaxial connector that can be manufactured economically.

Another object of our invention is to provide a connector of the character described that establishes satisfactory EMP, EMI, and RFI shielding.

A related object is to provide a connector of the character described that establishes reliable continuity between critical parts during installation of the male connector to the various types of threaded female connections, even though applied torque may fail to meet specifications.

Another essential object is to establish a proper ground electrical path with a socket even where the male connector is not fully torqued to the proper settings.

Another important object is to minimize resistive losses in a coaxial cable junction.

A still further object is to provide a connector of the character described suitable for use with demanding large, bandwidth systems approximating three GHz.

A related object is to provide an F-connector ideally adapted for home satellite systems distributing multiple, high definition television channels.

Another important object is to provide a connector of the character described that is weather proof and moisture resistant.

Another important object is to provide a compression F-connector of the character described that can be safely and properly installed without deformation of critical parts during final compression.

These and other objects and advantages of the present invention, along with features of novelty appurtenant thereto, will appear or become apparent in the course of the following descriptive sections.

### BRIEF DESCRIPTION OF THE DRAWINGS

In the following drawings, which form a part of the specification and which are to be construed in conjunction therewith, and in which like reference numerals have been employed throughout wherever possible to indicate like parts in the various views:

FIG. 1 is a frontal isometric view of a first embodiment of a coaxial connector in which the adaptations of our invention are incorporated;

FIG. 2 is a rear isometric view of the connector of FIG. 1;

FIG. 3 is an exploded, longitudinal sectional view of the connector of FIGS. 1 and 2;

FIG. 4 is a longitudinal view showing a modified coaxial connector, with portions thereof shown in section;

FIG. 5 is an enlarged, frontal isometric view of the body employed within the connector of FIG. 4, showing the biasing fingers;

FIG. 6 is an enlarged, rear isometric view of the body employed within the connector of FIG. 4;

FIG. 7 is an enlarged, front plan view of the body employed within the connector of FIG. 4;

FIG. 8 is a longitudinal view of a modified connector that is similar to the embodiment of FIG. 4, but which includes a sealing grommet seated in the post, with portions thereof shown in section;

FIG. 9 is an exploded, longitudinal sectional view of the connector of FIG. 8;

FIG. 10 is a longitudinal sectional view showing another embodiment of our coaxial connector;

FIG. 11 is an exploded, longitudinal sectional view of the coaxial connector of FIG. 10;

FIG. 12 is an enlarged, frontal isometric view of the body preferably employed within the connector of FIGS. 10-11, showing the biasing fingers;

FIG. 13 is an enlarged, rear isometric view of the connector body of FIGS. 10-12;

FIG. 14 is an enlarged plan view of the connector body of FIGS. 10-13; and,

FIG. 15 is a longitudinal view of another embodiment with portions thereof shown in section, showing a modified connector that is similar to the embodiment of FIGS. 10-14, but which includes a sealing grommet seated in the post.

### DETAILED DESCRIPTION OF THE SEVERAL VIEWS OF THE DRAWINGS

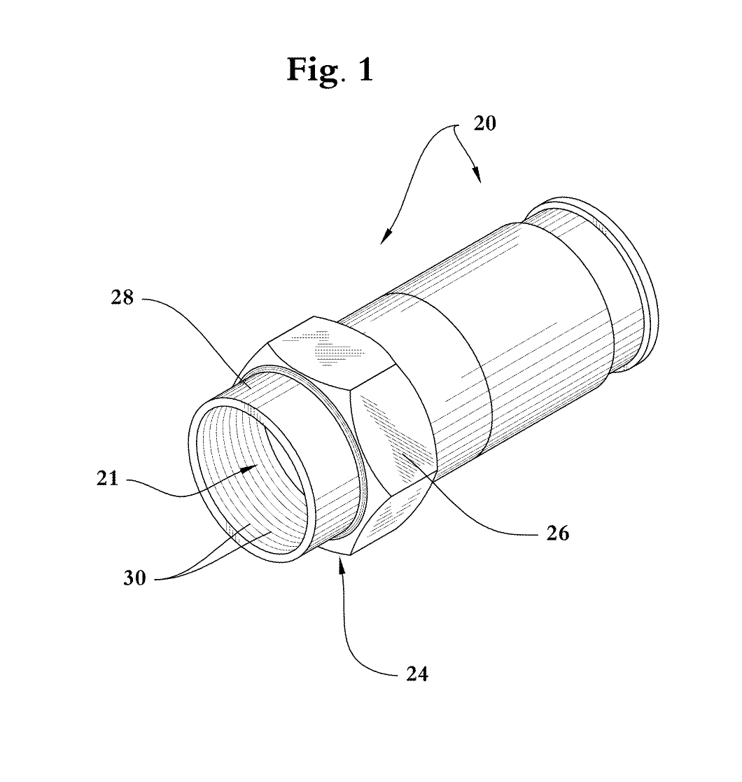

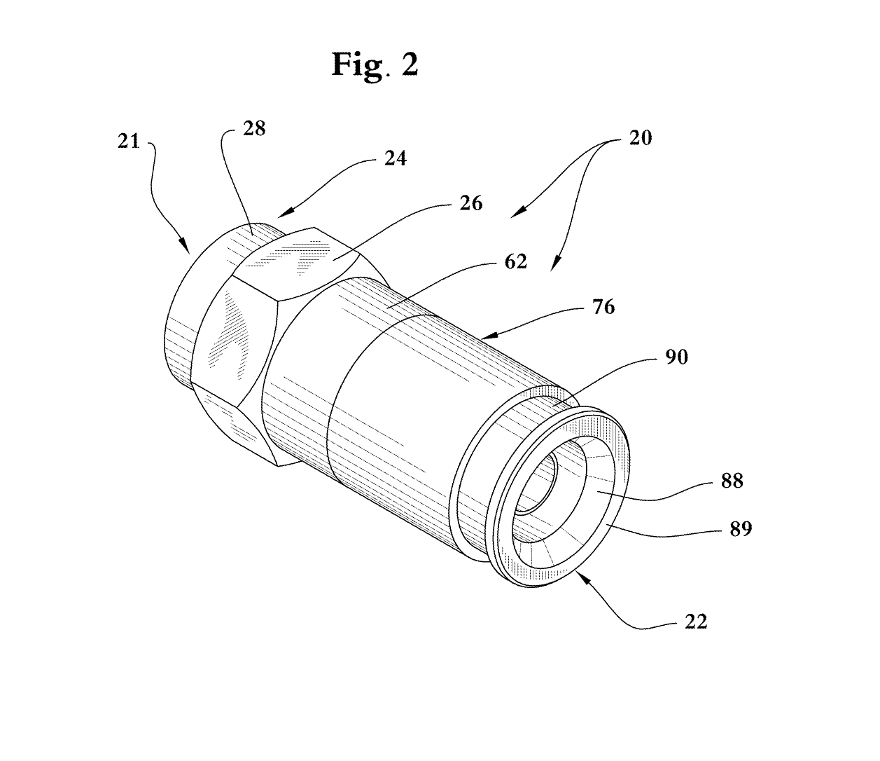

Coaxial cable F-connectors are well known in the art. The basic constituents of the compressible coaxial connector of FIGS. 1 and 2 are described in detail, for example, in prior U.S. Pat. No. 7,541,896 entitled “Sealed compression type coaxial cable F-connectors”, issued Nov. 30, 2010, and in prior U.S. Pat. No. 7,513,795, entitled “Compression type coaxial cable F-connectors”, issued Apr. 7, 2009, which are both owned by the same assignee as in the instant case, and which are both hereby incorporated by reference for purposes of disclosure as if fully set forth herein. However, it will be appreciated by those with skill in the art that coaxial cable connectors of other designs may be employed with the grounding adaptations described hereinafter.

Referring initially to FIGS. 1-4 of the appended drawings, a coaxial F-connector has been generally designated by the reference numeral 20. As will be recognized by those skilled in the art, connector 20 is a compressible F-connector, that is axially squeezed together longitudinally when secured to a coaxial cable. As is also recognized in the art, connector 20 is adapted to terminate an end of a properly prepared coaxial cable, which is properly inserted through the open bottom end 22 of the connector 20. Afterwards, the connector is placed within a suitable compression hand tool for compression. Afterwards the connector assumes the closed configuration of FIGS. 1 and 2, making electrical contact with the coaxial cable.

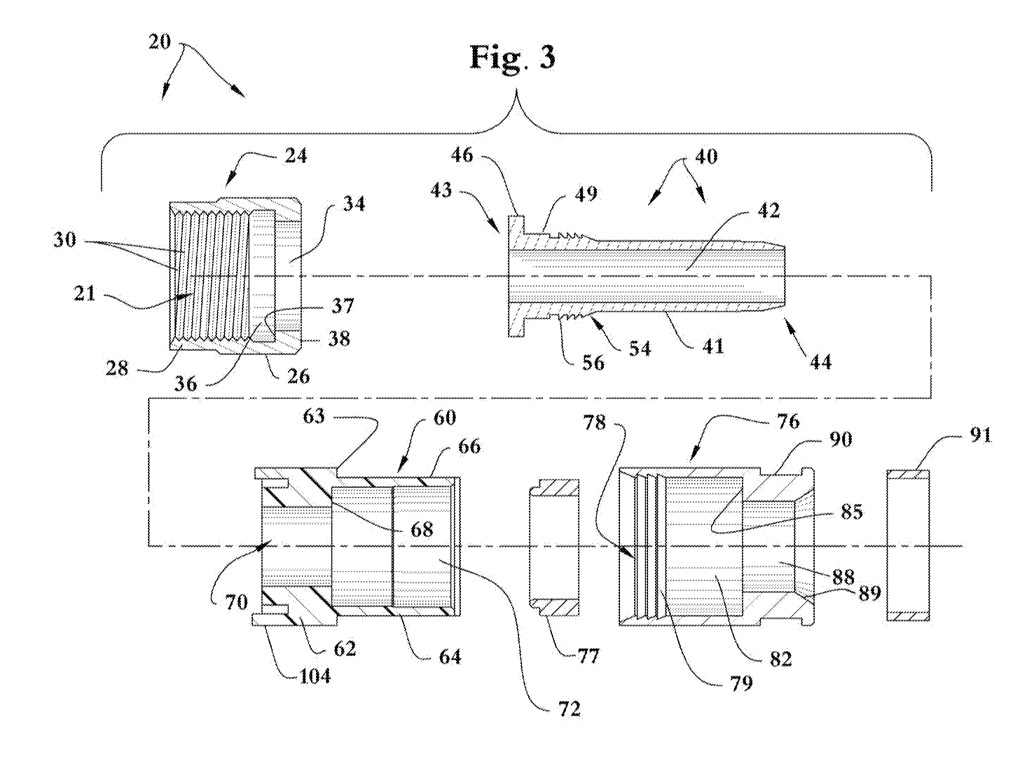

Connector 20 comprises a rigid, tubular, metallic nut 24 with a conventional faceted, preferably hexagonal drive head 26 integral with a protruding, coaxial stem 28. Nut 24 is torqued during installation. Conventional, internal threads 30 are defined in the stem interior for rotatably, threadably mating with a suitably-threaded socket. The open, tubular front end 21 connects through the open interior to a reduced diameter rear passageway 34 at the back of nut 24 (FIG. 3). Circular passageway 34 concentrically borders an annular, non-threaded, internal ring groove 36 that borders an internal shoulder 37 proximate passageway 34. There is an annular wall 38 at the rear of the nut 24.

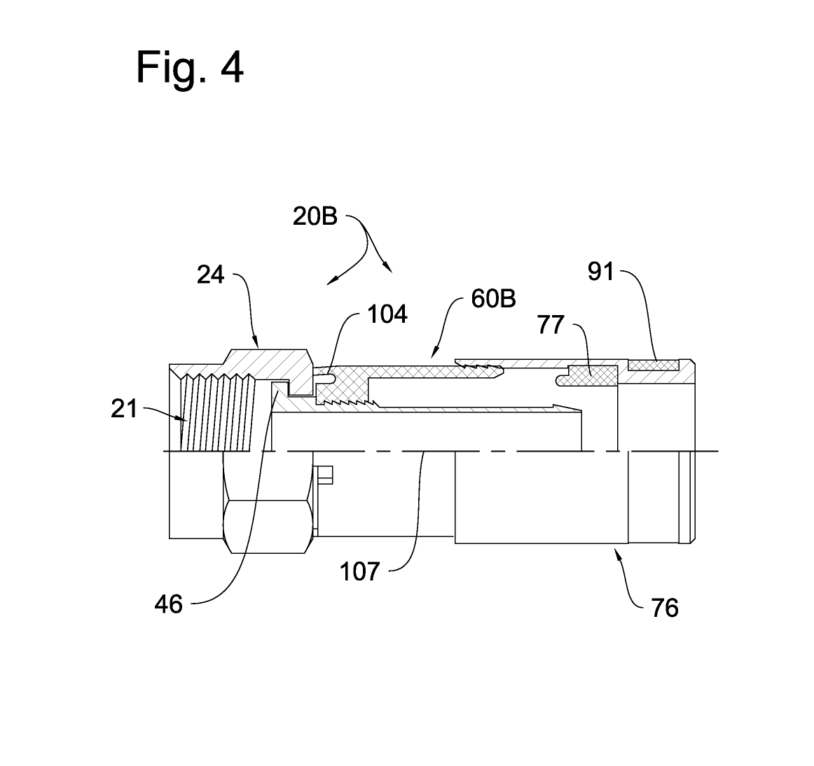

The elongated post 40 rotatably, coaxially passes through the hex headed nut 24 and establishes electrical contact between the braid of the coaxial cable end (not shown) and the metallic nut 24. The tubular post 40 defines an elongated shank 41 with a coaxial, internal passageway 42 extending between its front 43 and rear 44. Shank 41 may or may not have barbs 56 formed on it for engaging coaxial cable. A front, annular flange 46 (FIG. 3) borders an integral, reduced diameter neck 49. Preferably the post 40 has a barbed, collar 54 comprising multiple, external barbs 56 that are press fitted into the plastic body 60 described below. In assembly it is noted that post flange 46 (i.e., FIGS. 3, 4) axially contacts inner shoulder 37 (FIG. 3) within nut 24.

The rear, tapered end 44 of post shank 41 penetrates the prepared end of the coaxial cable, such that the inner, insulated center conductor coaxially penetrates passageway 42 and enters the front 21 of the nut 24. As recognized by those skilled in the are, the braided shield of the coaxial cable prepared end will be substantially positioned around the exterior of post shank 41 when the connector is compressed. Electrical contact, or continuity between the coaxial cable sheath, the post 40, and the nut 24 must be established in use. To enhance the likelihood of establishing reliable continuity, the connector body has been designed to pressure the post 40 against the nut 24 when the connector is assembled.

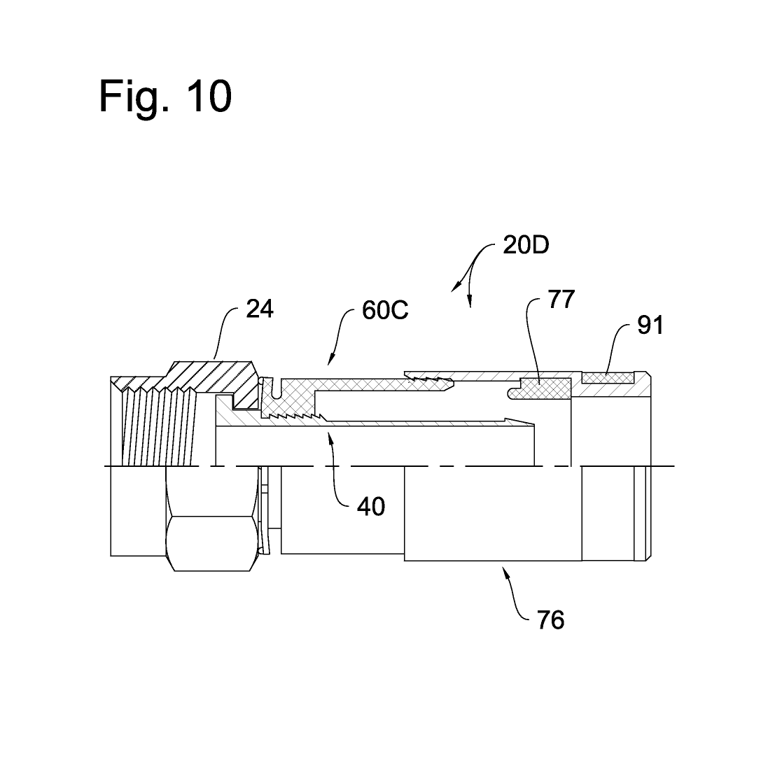

An elongated, hollow, tubular body 60, normally molded from plastic, is coupled to the post 40. Body 60 may comprises a tubular stop ring 62 that is integral with a reduced diameter body shank 64. Alternatively, the entire body may be of a uniform diameter, as is the case with bodies 60B (i.e., FIGS. 4-6) and 60C (i.e., FIG. 10) described hereinafter. The elongated, outer periphery 66 of shank 64 is preferably smooth and cylindrical. The larger diameter stop ring 62 has an annular, rear wall 63 that is coaxial with shank 64. Ring 62 defines an internal passageway 70 at the body front that communicates with larger diameter, passageway 72 extending from internal shoulder 68 to the body rear (FIG. 3). In assembly, (FIG. 4) the post 76 will coaxially penetrate passageways 70 and 72. In assembly, the barbed post collar 54 is frictionally seated within body passageway 70. As explained below, body 60 is especially adapted to mechanically pressure the nut 24 and post 40 together upon assembly to promote continuity.

An end cap 76 is pressed unto body 60, coaxially engaging the body shank 64. The rigid, preferably metallic end cap 76 smoothly, frictionally grips body shank 64, with maximum travel or displacement limited by stop ring 62. In other words, when the end cap 76 is compressed unto the body 60, and the connector 20 assumes a closed position (i.e., FIG. 2), annular wall 63 on the body stop ring 62 will limit axial deflection and travel of the end cap 76. Preferably the open end 78 of the end cap includes internally barbed region 79 that couples to the shank 64 of the body 60. When the body 60 and the cap 76 are compressed together, body travel is limited within cap passageway 82 by contact with internal cap shoulder 85. The reduced diameter passageway 88 is sized to receive coaxial cable, which is inserted through the flared opening 89.

An outer ring groove 90 at the cap rear can seat an optional external band 91 that can be added to establish a tactile “feel” for the installer. Band 91 can also enhance the aesthetic appearance of the connector, and it can facilitate color coding. Preferably there is a dual diameter seal 77 seated against shoulder 85 within end cap 76. Seal 77 is explained in detail in U.S. Pat. No. 7,841,896 issued to Shaw, et. al. on Nov. 30, 2010, entitled “Sealed Compression type Coaxial Cable F-Connectors”, which is hereby incorporated by reference for purposes of disclosure as if fully set forth herein.

Grounding or continuity is established in part by mechanical and electrical contact between internal nut shoulder 37 (FIG. 3) and post flange 46. The coaxial cable sheath bearing against the post shank 41 would thus electrically interconnect with the post and the nut 24, which would in turn establish electrical contact with the socket to which nut 24 is attached. However, grounding or continuity generally depend on proper tightening of the nut 24. In the real world, installers often neglect to properly tighten the nut 24, so less internal, mechanical pressure is available within the F-connector to urge the parts discussed above into mechanically abutting, electrically conductive contact. Accordingly, each connector described herein includes a body that has been adapted to encourage mechanical contact between nut 24 and post 40 for maintaining continuity.

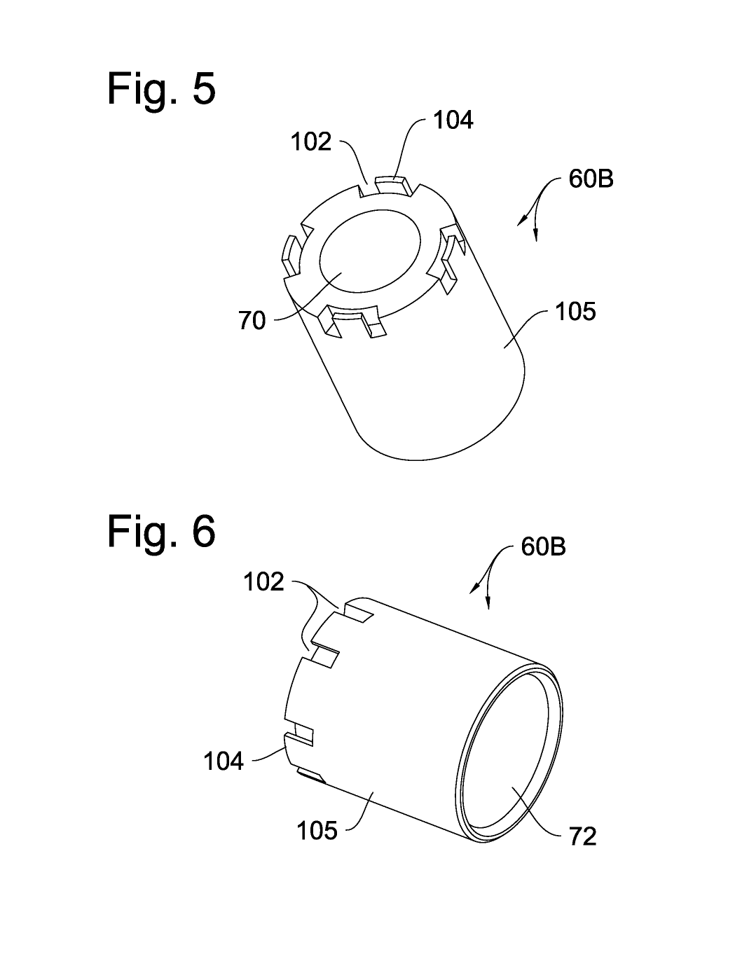

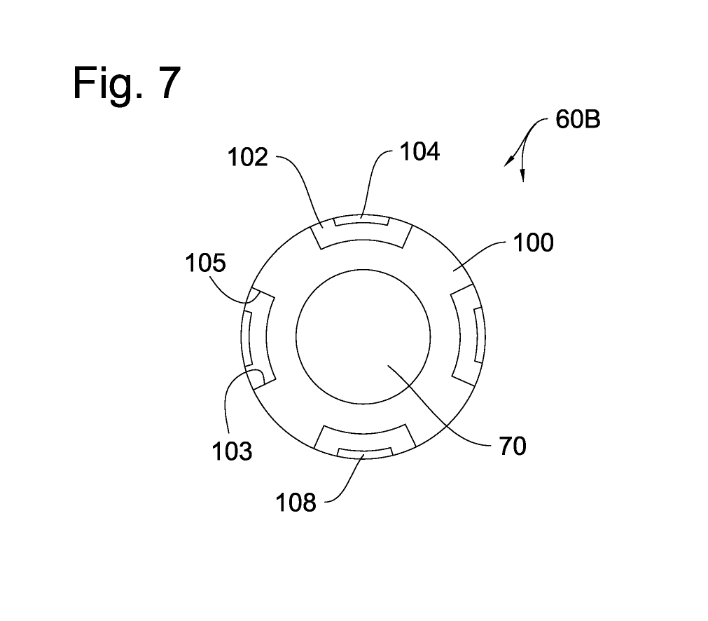

An alternative connector 20B (FIG. 4) has a slightly modified body 60B. The preferred body 60B is of a uniform outer diameter and thus lacks the stop ring 62 (FIG. 3) of body 60, but functions substantially similarly. As best seen in FIGS. 5 and 7, body 60B comprises an annular front surface 100 that is coaxial with passageway 70. There are a plurality of radially spaced apart notches 102, preferably four, defined at the front of the each molded plastic body 60 or 60B. There is an offset finger 104 associated with each notch 102. The resilient fingers 104 are integral with each body 60 or 60B, and are coextensive with the body's neighboring outer cylindrical surfaces. Each of the fingers 104 extend outwardly from annular surface 100 a predetermined distance from the front of the body 60 or 60B, and they run parallel to the longitudinal axis 107 (FIG. 4) of the connector. Preferably each finger 104 is positioned midway between the opposite ends 103, 105 (FIG. 7) of a notch 102.

The offset fingers 104 terminate in arcuate, outer surfaces 108 (FIG. 7). In assembly (FIG. 4) fingers 104 will abut and pressure the rear surface 38 (FIG. 3) of the nut 24. Thus mechanical contact between nut 24 and post 40 will be promoted by fingers 104. By comparing FIGS. 3 and 4 it will be appreciated that the fingers 104 insure contact between the inner annular shoulder (FIG. 3) in nut 24, and the post flange 46.

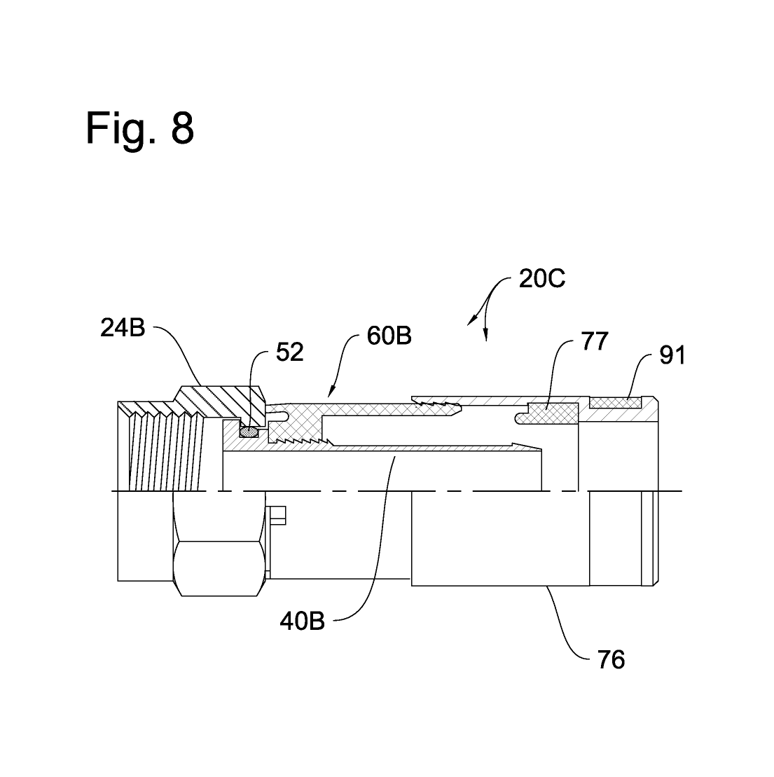

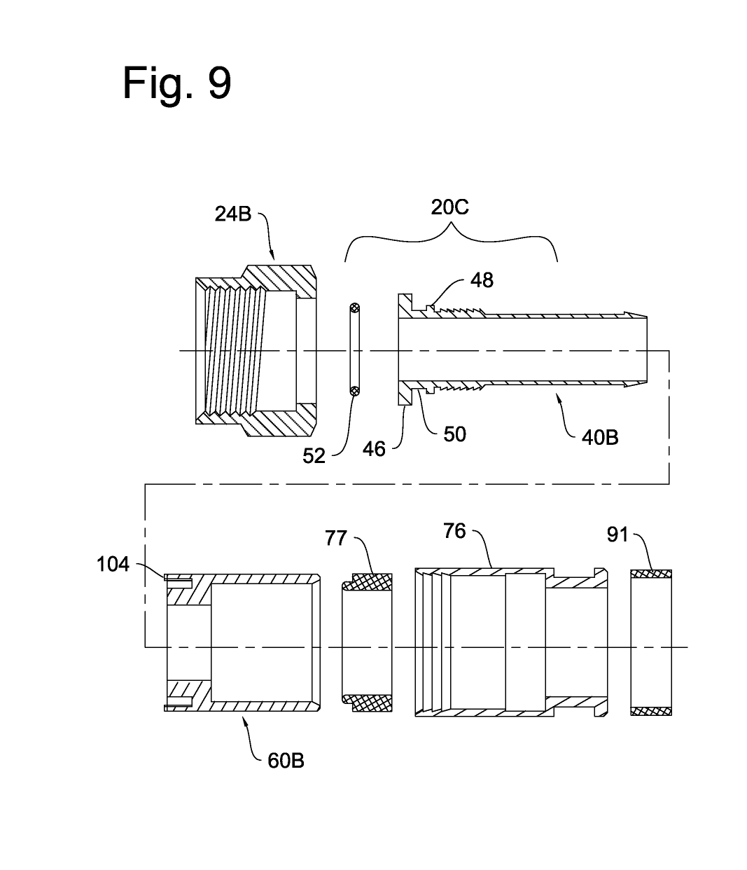

Alternative connector 20C (FIGS. 8-9) includes the same resilient body 60B as used in connector 20B (FIG. 4). However, the elongated post 40B comprises a spaced-apart secondary flange 48 separated from flange 46 by a ring groove 50. A conventional, resilient O-ring 52 is seated within post ring groove 50 when the connector 20C is assembled. O-ring 52 is preferably made of a silicone elastomer, and its function is to provide a moisture seal. As apparent from FIG. 4, in assembly O-ring 52 will be compressed about its periphery within post ring groove 50 by squeezing contact with nut 24B. Fingers 104 on body 60B will function as before to urge the nut and post together to maintain electrical continuity.

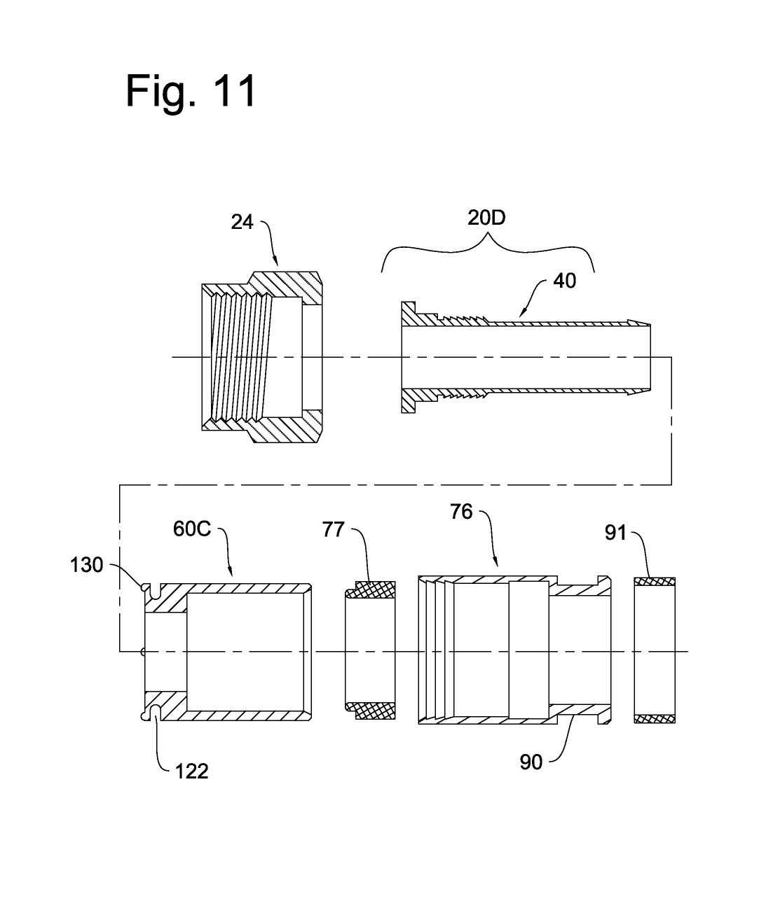

Connector 20D (FIGS. 10-11) is substantially similar to connector 20B (FIG. 4) except that a modified body 60C is employed. As is the case with all connector bodies described herein, body 60C biases the hex nut and the internal post together upon assembly.

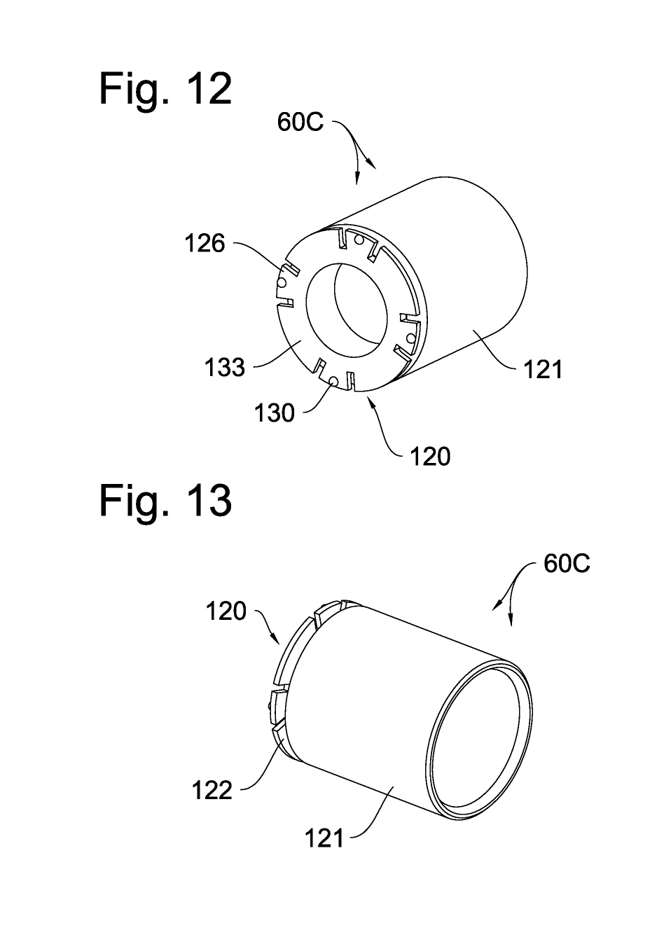

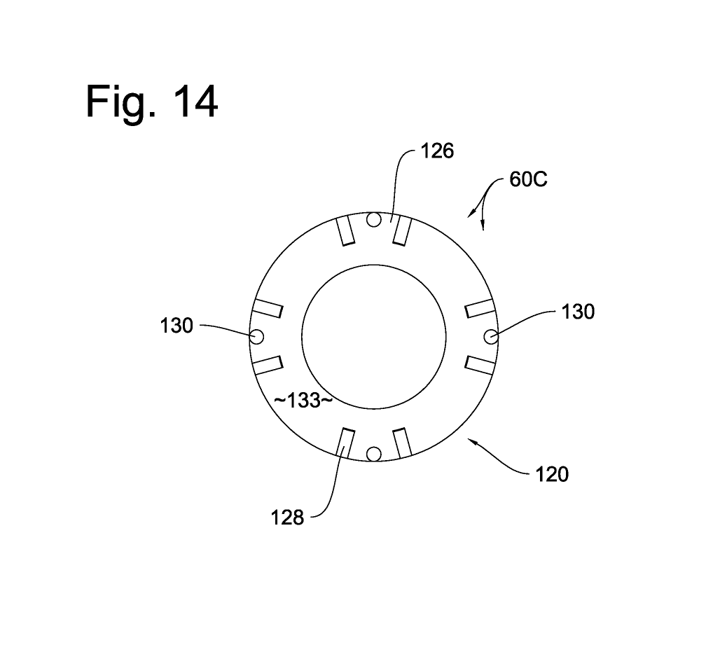

As best seen in FIGS. 12-14, body 60C comprises a substantially annular, front biasing flange 120 that is spaced apart from the cylindrical periphery 121 of body 60C across an encircling ring groove 122 (FIG. 11). The resilient biasing flange 120 has a plurality of somewhat trapezoidally shaped fingers 126 (preferably four) that are radially spaced about the flange periphery. Each resilient finger 126 is bounded by a pair of relief slots 128 that facilitate bending. Prior to compassion of the connector, the fingers 126 are coplanar with flange 120. Fingers 126 each have an integral, preferably hemispherical projection 130 (FIGS. 12, 14) that, as best seen in FIG. 11, is offset from the front, annular face 133 (FIG. 14) of flange 120. In assembly (FIG. 10), the convex projections 130 will bias nut 24 into assured contact with internal post 40. The resilient fingers 126 will yieldably press projections 130 against nut 24.

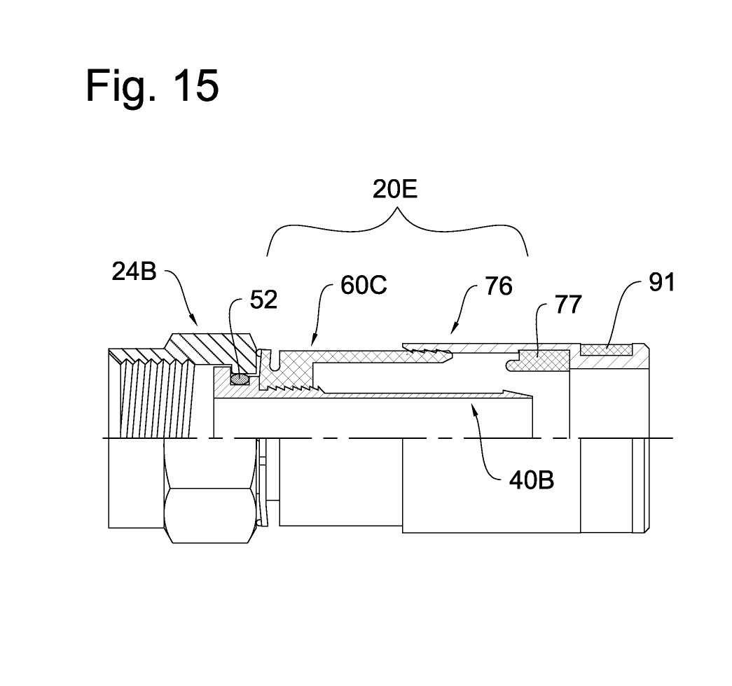

Connector 20E (FIG. 15) is similar to connector 20D, using the same fingered body 60C discussed above, which functions virtually identically, However, connector 20E employs the same post 40B and nut 24B as used by connector 20C (FIGS. 8, 9). As with connector 20C, an O-ring 52 encircling the post 40B is employed for sealing.

From the foregoing, it will be seen that this invention is one well adapted to obtain all the ends and objects herein set forth, together with other advantages which are inherent to the structure.

It will be understood that certain features and subcombinations are of utility and may be employed without reference to other features and subcombinations. This is contemplated by and is within the scope of the claims.

As many possible embodiments may be made of the invention without departing from the scope thereof, it is to be understood that all matter herein set forth or shown in the accompanying drawings is to be interpreted as illustrative and not in a limiting sense.

What is claimed is:

1. A compressible coaxial connector comprising:
a nut adapted to threadably fasten the connector;
an elongated, hollow post comprising a portion that internally abuts the nut;
a hollow, tubular body coaxially disposed over said post, the body comprising a plurality of spaced-apart fingers for biasing the nut to promote mechanical and electrical contact between the nut and the post; and,
an end cap adapted to be coupled to said body.

2. The connector as defined in claim 1 wherein the body and the fingers are resilient.

3. The connector as defined in claim 1 wherein the body comprises a plurality of radially spaced apart notches defined at its front.

4. The connector as defined in claim 3 wherein each finger emanates from said body proximate a notch.

5. The connector as defined in claim 4 wherein the body has an annular front surface and said fingers are offset from said annular surface.

6. The connector as defined in claim 5 wherein the connector has a longitudinal axis and said fingers run parallel with said axis.

7. The connector as defined in claim 1 wherein the body comprises a resilient, front biasing flange, and the flange comprises a plurality of integral, coplanar fingers.

8. The connector as defined in claim 7 wherein said fingers are radially spaced about the flange periphery.

9. The connector as defined in claim 8 wherein each finger is bounded by a pair of relief slots that facilitate bending.

10. The connector as defined in claim 9 wherein each finger has an integral, convex projection that is offset from the flange.

11. The connector as defined in claim 10 wherein the body is resilient.
